(19) United States
(12) Patent Application Publication
(10) Pub. No.: US 2021/0316238 A1
(43) Pub. Date: Oct. 14, 2021

(54) NONWOVEN MATERIAL FOR FILTRATION AND METHOD OF MAKING THE SAME

(71) Applicants: PFNONWOVENS LLC, Hazleton, PA (US); PFNONWOVENS HOLDING S.R.O, Prague 1 (CZ)

(72) Inventors: Karthik Ramaratnam, Anderson, SC (US); John C. Parsons, Annville, PA (US); Pavlina Kasparkova, Znojmo (CZ); Antonius Lambertus Johanne De Beer, Loveland, OH (US); Christian Skokowski, Drums, PA (US); Pam Lynn Keech, Zion Grove, PA (US)

(21) Appl. No.: 17/226,562

(22) Filed: Apr. 9, 2021

Related U.S. Application Data
(60) Provisional application No. 63/007,809, filed on Apr. 9, 2020.

(51) Int. Cl. B01D 39/16; A62B 23/02; D04H 1/56; D04H 1/724; D04H 3/16; A41D 31/14

(52) U.S. Cl. CPC B01D 39/163; A41D 13/11; D04H 1/56; D04H 1/724; D04H 3/16; A41D 31/145; B01D 2239/0407; B01D 2239/0618; B01D 2239/0627; B01D 2239/0622; B01D 2239/065; B01D 2239/10; B01D 2239/1258; B01D 2239/1291; A41D 2500/30; D10B 2505/04; D10B 2501/042; A62B 23/025

(57) ABSTRACT

A nonwoven fabric including a first layer made of spunbond fibers and a second layer made of meltblown fibers, wherein the first layer is bonded with the second layer, and wherein the spunbond fibers of the first layer are interspersed with the meltblown fibers of the second layer so that the nonwoven fabric exhibits enhanced breathability and filtration properties. In exemplary embodiments, the nonwoven fabric may be used in personal protective equipment, such as, for example, face masks and respirators.

### RELATED APPLICATIONS

This application claims priority to and the benefit of U.S. Provisional Application No. 63/007,809, entitled NONWOVEN MATERIAL FOR FILTRATION AND METHOD OF MAKING THE SAME and filed Apr. 9, 2021, the contents of which are incorporated herein by reference in their entirety.

### FIELD OF THE INVENTION

This invention relates generally to nonwoven fabrics or webs which are formed from fibers of thermoplastic resin, and in particular to nonwoven fabrics or webs used as a component of personal protective equipment such as a face mask or a respirator or protective clothes and methods of making such nonwoven fabrics or webs.

### BACKGROUND

It is known to use spunmelt nonwoven material for filtration purposes. For example, spunbond fibers are often combined with finer meltblown fibres to form so-called SMS compositions, which may be used to provide filtration in personal protective equipment, such as facemasks. In such applications, the spunbond layers provide mechanical support, while the meltblown layers provide barrier properties or filtration efficiency. Conventionally, the spunbond and meltblown layers for protective equipment are produced separately and then combined together into the final product.

### SUMMARY OF THE INVENTION

Meltblown (MB) fabrics are conventionally used as filter layers. However, pure MB fabrics are typically very weak in terms of fabric strength and most often the manufacturing process for pure MB fabrics are throughput limited, thereby increasing manufacturing costs of such fabrics.

In accordance with exemplary embodiments of the present invention, a “Spunbond-Meltblown” (SM) fabric construction is used to provide barrier properties at the same or even higher levels as compared to those provided by MB fabric while also providing high structural integrity (fabric strength) and optimal drape for use as a filter layer in personal protective equipment, such as, for example, face masks. The inventive SM fabric construction has a high degree of fiber tortuosity due to the presence of both (fine denier) spunbond and meltblown filaments that are thermally bonded together. Without being bound by theory, it is believed that the bonded spunbond layer provides the structural rigidity to the meltblown layer along with the higher degree of fiber tortuosity, thereby enhancing the filtration ability of the overall fabric construction compared to a pure meltblown fabric.

The inventive fabric allows for replacement of the conventional three-ply mask with a two-ply mask, thereby simplifying the converting process with two unwind stands as compared to three unwind stands and making the process more efficient and cost effective.

A nonwoven fabric according to an exemplary embodiment of the present invention comprises: a first layer made of spunbond fibers; and a second layer made of meltblown fibers, wherein the first layer is bonded with the second layer, and wherein the spunbond fibers of the first layer are interspersed with the meltblown fibers of the second layer so that the nonwoven fabric exhibits enhanced breathability and filtration properties.

In an exemplary embodiment the nonwoven fabric further comprises a third layer made of spunbond fibers, wherein the third layer is in direct contact with the second layer of meltblown fibers, and wherein the spunbond fibers of the third layer are hydrophilized so that the second layer of meltblown fibers exhibits a surface energy gradient.

In an exemplary embodiment of the nonwoven fabric the first layer is bonded to the second layer by a calendering process in which a spunbond batt and the second layer of meltblown fibers are fed through a nip formed by calendering rolls.

In an exemplary embodiment of the nonwoven fabric the calendering rolls comprise a smooth roll and a patterning roll having a pattern of protrusions.

In an exemplary embodiment of the nonwoven fabric the first layer of spunbond fibers is in direct contact with the patterning roll during the calendering process.

In an exemplary embodiment of the nonwoven fabric the second layer of meltblown fibers is in direct contact with the patterning roll during the calendering process.

In an exemplary embodiment of the nonwoven fabric the second layer of meltblown fibers is an outer layer of the fabric.

In an exemplary embodiment the nonwoven fabric forms part of a facemask.

In an exemplary embodiment of the nonwoven fabric the first spunbond layer comprises fibers having an average thickness of 12 to 20 microns, preferably 12 to 18 microns, even more preferably 12 to 16 microns, and even more preferably 12 to 15 microns.

In an exemplary embodiment of the nonwoven fabric the first spunbond layer is produced from polyolefin.

In an exemplary embodiment of the nonwoven fabric the first spunbond layer is produced from polypropylene polymer.

In an exemplary embodiment of the nonwoven fabric the first spunbond layer comprises additives.

In an exemplary embodiment of the nonwoven fabric the first spunbond layer comprises additives with a high dielectric constant such as barium titanate (BaTiO3), magnesium stearate or tourmaline in a polymer masterbatch.

In an exemplary embodiment of the nonwoven fabric the second meltblown layer is produced from polyolefin.

In an exemplary embodiment of the nonwoven fabric the second meltblown layer is produced from polypropylene polymer.

In an exemplary embodiment of the nonwoven fabric the second meltblown layer comprises additives.

In an exemplary embodiment of the nonwoven fabric the second meltblown layer comprises additives with a high dielectric constant such as barium titanate (BaTiO₃), magnesium stearate or tourmaline in a polymer masterbatch.

In an exemplary embodiment of the nonwoven fabric the bond area percentage may be lower than 25%, preferably lower than 22%, preferably lower than 20%, and even more preferably lower than 18.5%, but at least 2%, more preferably at least 5%, more preferably at least 8% and even more preferably at least 10%.

In an exemplary embodiment of the nonwoven fabric the fabric comprises small bonding impressions with a size lower than 1 mm², preferably lower than 0.7 mm², preferably lower than 0.5 mm², and preferably lower than 0.4 mm², where size in this context means the surface area of the lowest part of the bonding impression or imprint.

In an exemplary embodiment of the nonwoven fabric the second meltblown layer comprises at least two sublayers.

In an exemplary embodiment of the nonwoven fabric the second meltblown layer comprises a first sublayer (C) of thicker fibers having an average fiber thickness in the range of 2-10 microns, preferably 3-6 microns.

In an exemplary embodiment of the nonwoven fabric the second meltblown layer comprises a second sublayer (F) with at least 20%, preferably at least of 25%, more preferably at least 30%, even more preferably at least 35% of the fibers having a thickness below 1.5 microns, preferably below 1.3 microns, more preferably below 1.1 microns, and even more preferably below 1 micron.

In an exemplary embodiment of the nonwoven fabric the second meltblown layer has a basis weight of at least 5 gsm, preferably at least 7 gsm, preferably at least 9 gsm, preferably at least 11 gsm.

In an exemplary embodiment of the nonwoven fabric the second meltblown layer has a maximum basis weight of 60 gsm, preferably 50 gsm, preferably 40 gsm, preferably 30 gsm, preferably 25 gsm, more preferably 20 gsm.

In an exemplary embodiment of the nonwoven fabric the spunbond layer of the SM nonwoven fabric has a basis weight of at least 5 gsm, preferably at least 7 gsm, preferably at least 9 gsm, preferably at least 11 gsm.

In an exemplary embodiment of the nonwoven fabric the spunbond layer of the SM nonwoven fabric has a maximum basis weight of 60 gsm, preferably 55 gsm, preferably 45 gsm, preferably 35 gsm, preferably 30 gsm, preferably 25 gsm, preferably 20 gsm, more preferably 15 gsm.

In an exemplary embodiment of the nonwoven fabric the spunbond layer to meltblown layer basis weight ratio of the SM nonwoven fabric is in a range of 0.5-1.5, preferably 0.6-1.4, preferably 0.7-1.3, preferably 0.8-1.2, more preferably 0.9-1.1.

In an exemplary embodiment of the nonwoven fabric the SM nonwoven fabric has a BFE (Bacterial Filtration Efficiency) higher than 80%, preferably higher than 85%, preferably higher than 90%, preferably higher than 95%, more preferably higher than 98%.

In an exemplary embodiment of the nonwoven fabric the SM nonwoven fabric has a PFE (Particle Filtration Efficiency) higher than 80%, preferably higher than 85%, preferably higher than 90%, preferably higher than 95%, more preferably higher than 98%.

In an exemplary embodiment of the nonwoven fabric the SM nonwoven fabric has a hydrohead of at least 20 mbar, preferably of at least 25 mbar, preferably of at least 30 mbar, preferably of at least 35 mbar, more preferably at least 40 mbar.

In an exemplary embodiment of the nonwoven fabric the SM nonwoven fabric has an HOM (Handle-O-Meter) value lower than 50 g, preferably lower than 45 g, preferably lower than 40 g, preferably lower than 35 g, more preferably lower than 30 g, where HOM in this context is the average of the CD and MD values.

In an exemplary embodiment of the nonwoven fabric the SM nonwoven fabric has a thickness in the range of 0.10 to 0.60 mm, preferably 0.10 to 0.50 mm, preferably 0.10 to 0.40 mm, preferably 0.10 to 0.35 mm, more preferably 0.15 to 0.35 mm.

In an exemplary embodiment of the nonwoven fabric the SM nonwoven fabric has an air permeability higher than 20 cfm, preferably higher than 25 cfm, preferably higher than 30 cfm, preferably higher than 35 cfm, more preferably higher than 40 cfm.

In an exemplary embodiment of the nonwoven fabric the SM nonwoven fabric has a Delta P (differential pressure) lower than 10.0, preferably lower than 8.0, preferably lower than 6.0, preferably lower than 5.0, preferably lower than 4.5, preferably lower than 4.0, more preferably lower than 3.5.

In an exemplary embodiment of the nonwoven fabric the SM nonwoven fabric has a nGMT higher or equal to 15, preferably higher or equal to 17, with advance higher or equal to 19.

In an exemplary embodiment of the nonwoven fabric the SMP nonwoven fabric has a BFE (Bacterial Filtration Efficiency) higher than 80%, preferably higher than 85%, preferably higher than 90%, preferably higher than 95%, more preferably higher than 98%.

In an exemplary embodiment of the nonwoven fabric the SMP nonwoven fabric has a PFE (Particle Filtration Efficiency) higher than 80%, preferably higher than 85%, preferably higher than 90%, preferably higher than 95%, more preferably higher than 98%.

A method of making a nonwoven fabric according to an exemplary embodiment of the present invention comprises: depositing spunbond fibers on a moving belt to form a spunbond batt; depositing meltblown fibers on the spunbond batt to form a meltblown layer; conveying the spunbond batt and the meltblown layer to a bonding station; and bonding the spunbond batt to the meltblown layer at the bonding station by a calendering process in which the spunbond batt and the meltblown layer are fed through a nip formed by calendering rolls, wherein the bonding step results in the spunbond fibers of the spunbond batt being interspersed with the meltblown fibers of the meltblown layer so that the nonwoven fabric exhibits enhanced breathability and filtration properties.

In an exemplary embodiment of the method the roll with a smooth cylinder surface faces and is in direct contact with the spunbond layer, and the calender rolls are heated to a range 148° C.-152° C.

In an exemplary embodiment of the method the roll with a smooth cylinder surface faces and is in direct contact with the spunbond layer, the calender roll with protrusions is heated to a maximum of 152° C.

In an exemplary embodiment of the method the roll with a smooth cylinder surface faces and is in directed contact with the meltblown layer; the calender roller with protrusions can be heated to a range of 148° C.-162° C. and the roller with a smooth cylinder surface can be heated to a maximum at 152° C.

In an exemplary embodiment of the method the nip pressure is preferably higher than 75 daN/cm (decaNewton/centimeter), preferably higher than 80 daN/cm.

In an exemplary embodiment of the method nip pressure is lower than 100 daN/cm, preferably lower than 95 daN/cm, and more preferably lower than 90 daN/cm.

In an exemplary embodiment of the method the nip pressure is in a range of 75 to 95 daN/cm.

In an exemplary embodiment of the method the Melt Flow Rate of the spunbond grade is in a range of 15-50 g/10 min, preferably in a range of 20-40 g/10 min.

In an exemplary embodiment of the method the spunbond throughput is lower than 245 kg/h/m, more preferably lower than 225 kg/h/m, even more preferably below 200 kg/h/m.

In an exemplary embodiment of the method the spunbond production beams are ran at below ¾ of standard throughput production range, more preferably below half of standard throughput production range, even more preferably below ¼ of standard throughput production range.

In an exemplary embodiment of the method the Melt Flow Rate of the meltblown grade is in a range of 500-2000 g/10 min

In an exemplary embodiment of the method the Melt Flow Rate of meltblown grade is within a range of 1000-2000 g/10 min, preferably 1200-1750 g/10 min.

In an exemplary embodiment of the method the meltblown layer is produced from at least two melblown beams where at least one of them produce fibers from the melblown grade at a Melt Flow Rate in the range of 1000-2000 g/10 min, preferably 1200-1750 g/10 min and at least one of them produce fibers from the melblown grade at a Melt Flow Rate in the range of 400-1000 g/10 min, preferably 500-800 g/10 min.

### Definitions

A “nonwoven” is a manufactured sheet or web of directionally or randomly oriented fibres which are first formed into a batt and then consolidated and bonded together by friction, cohesion, adhesion or one or more patterns of bonds and bonding impressions created through localized compression and/or application of pressure, heat, ultrasonic, or heating energy, or a combination thereof. The term does not include fabrics which are woven, knitted, or stitch-bonded with yarns or filaments. The fibres may be of natural or man-made origin and may be staple or continuous filaments or be formed in situ. Commercially available fibres have diameters ranging from about 0.0005 mm to about 0.25 mm and they come in several different forms: short fibres (known as staple, or chopped), continuous single fibres (filaments or monofilaments), untwisted bundles of continuous filaments (tow), and twisted bundles of continuous filaments (yam). Nonwoven fabrics can be formed by many processes including but not limited to melt-blowing, spun-bonding, spun-melting, solvent spinning, electro-spinning, carding, film fibrillation, melt-film fibrillation, air-laying, dry-laying, wet-laying with staple fibres and combinations of these processes as known in the art. The basis weight of nonwoven fabrics is usually expressed in grams per square meter (gsm).

A “batt” is used herein to refer to fibre materials prior to being bonded to each other. A “batt” comprises individual fibres, which are usually unbonded to each other, although a certain amount of pre-bonding between fibres may be performed, and this pre-bonding may occur during or shortly after the lay-down of fibres in a spun-melt process, for example. This pre-bonding, however, still permits a substantial number of the fibres to be freely movable such that they can be repositioned. A “batt” may comprise several layers, resulting from depositing fibers from several spinning heads in a spun-melt process, and distributions of a fiber diameter thickness and a porosity in the “sub layers” laid-down from individual heads do not differ significantly. Adjacent layers of fibers need not be separated from each other by sharp transition, individual layers may blend partly in the area around the boundary.

The term “spunbond fibers” refers to fibers made via a process involving extruding a molten thermoplastic material as filaments from a plurality of fine, typically circular, capillaries of a spinneret, with the filaments then being attenuated by applying a draw tension and drawn mechanically or pneumatically (e.g., mechanically wrapping the filaments around a draw roll or entraining the filaments in an air stream). The filaments may be quenched by an air stream prior to or while being drawn. The continuity of the filaments is typically preserved in a spunbond process. The filaments may be deposited on a collecting surface to form a web of randomly arranged substantially continuous filaments, which can thereafter be bonded together to form a coherent nonwoven fabric. Exemplary spunbond process and/or webs formed thereby may be found in U.S. Pat. Nos. 3,338,992; 3,692,613, 3,802,817; 4,405,297 and 5,665,300

As used herein, the term “meltblown fibers” refers to fibers made via a process whereby a molten material (typically a polymer), is extruded under pressure through orifices in a spinneret or die. High velocity hot air impinges upon and entrains the filaments as they exit the die to form filaments that are elongated and reduced in diameter and might be fractured so that fibers of generally variable thickness are produced. This differs from a spunbond process whereby the continuity of the filaments is preserved along their length. An exemplary meltblown process may be found in U.S. Pat. No. 3,849,241 to Buntin et al. Meltblown fibres comprise fibres produced by meltblown technology with average size of 1-10 microns and also sub-micron fibres. Similar fibers can be produced by other technologies. For example, fibers produced by Spun-Blown technology (Biax-Fiberfilm Corporation, Greenville, Wis., USA) at certain settings can be very similar to or the same as meltblown fibers. Such fibers are for the purposes of this invention considered “meltblown fibers”.

The terms “fiber” and “filament” used to describe spunbond or meltblown fibers/filaments are herein used interchangeably.

The term “sub-micron fibres” refers to normal fibres with a diameter below 1 micron. Usually, however not necessarily, these fibres are substantially thicker than “nano-fibres” (the diameter of which should be less than 100 nanometres). Sub-micron fibres have a diameter typically greater than approximately 200 nm, frequently greater than approximately 500 nm.

The term “barrier layer” or “filtration layer” herein refers to a layer of fibres or a nonwoven textile, which is able to stop the flow of material. For example, to stop a flow of liquid and to retain it in a designated area. For example, to stop the liquid drops or micro drops in the flow of gas (for example air) and retain it on the barrier layer. For example, to stop or significantly reduce the amount of the bacteria or harmful microorganisms or viruses in the flow of gas (air)

The term “BFE” or “Bacterial Filtration Efficiency” measures how well the medical face mask filters out bacteria when challenged with a bacteria-containing aerosol. ASTM specifies testing with a droplet size of 3.0 microns containing Staph. Aureus (average size 0.6-0.8 microns). In order to be called a medical/surgical mask, a minimum 95% filtration rate is required. Moderate and high protection masks must have bacterial filtration rates greater than 98%.

The term “PFE” or “Submicron Particle Filtration Efficiency” measures how well a hospital mask filters sub-micron particles with the expectation that viruses will be filtered in a similar manner. The higher the percentage, the better the mask filtration. Although testing is available using a particle size from 0.1 to 5.0 microns, ASTM F2100-11 specifies that a particle size of 0.1 micron be used.

“Bonding roller”, “calender roller” and “roller” are used interchangeably hereinafter.

A “bonding impression” in a nonwoven web is the surface structure created by the impression of a bonding protrusion on a calender roller into a nonwoven web. A bonding impression is a location of deformed, intermeshed or entangled, and melted or thermally fused, materials from fibres superimposed and compressed in a z-direction beneath the bonding protrusion, which form a bond or a bonding area. The individual bonds may be connected in the nonwoven structure by loose fibres between them. The shape and size of the bonding impression approximately corresponds to the shape and size of the bonding surface of a bonding protrusion on the calender roller. The side of the fabric in contact with the bonding protrusions on a calender roller and in which the bonding impressions are mainly formed is termed a “textured” side of the fabric. The side of the fabric in contact with a smooth calender roller and in which the bonding impressions are partially formed is termed a “smooth” side of the fabric.

“Bond area percentage” of nonwoven fabric represents a ratio of an area occupied by bonding impressions to a total surface of a nonwoven fabric expressed as percentage.

As used herein, the term “layer” refers to a sub-component or element of a web. A “layer” may be in the form of a plurality of fibers made from a single beam or multiple beams of same type. For example, an SM layer structure may be produced using two beams—one spunbond and one meltblown, or may be produced with a multi-beam line—for example: spunbond, meltblown, meltblown, meltblown, or spunbond, spunbond, meltblown, or spunbond, spunbond, meltblown, meltblown, meltblown etc.

As used herein, the term “Microparticles” refers to particles between 0.1 and 1000 μm in size. Microparticles encountered in daily life may include pollen, sand, dust, flour, powdered sugar, drops or droplets of liquids, bacteria, germ, virus etc.

As used herein, the term “additive” refers to any chemical substance that is applied into molten polymer or on the fibres surface during or after the fabric production. For example, additive can be in form of particles (e.g. TiO2 as white dye) or in form of polymer (e.g. L-MODU as process additives from Idemitsu) or in form of liquid solution (for example biocides applied by spray or kiss-roll) or in form of chemical change (e.g. plasma or corona treatment of fabric or fibre surface) etc. Additives can be applied on all fabric or layer, or can be applied locally on surface, part of surface or part of layer or fabric. The additive content of the additive in the polymer can be up to 25%.

The term “personal protective equipment” is used throughout this application to include any type of clothing such as a face mask, coat, vest, hat, apron, boots and/or gloves which may be used to protect a wearer from hazardous or potentially hazardous environments.

The term “facemask” as used in this application may comprise a face piece, lens or any protective covering of a wearer's face satisfactory for use in a hazardous or potentially hazardous condition. The term “facemask” refers to both so called “procedure mask” which has a lower performance rating (used for generally “respiratory etiquette” to prevent clinicians, patients and visitors from spreading germs by talking, coughing, or sneezing.) and “surgical mask” which has a very high-performance rating. The term “surgical masks” covers also ASTM-rated medical masks. Level 1 masks have the lowest barrier of protection, while Level 3 masks have the highest barrier of protection. For greater clarity on the differences, refer to the information in Tables 1 and 2 below:

TABLE 1
ASTM PROTECTION VS. INTENDED USAGE

| LEVEL 1 (LOW) | LEVEL 2 (MODERATE) | LEVEL 3 (HIGH) |
|---|---|---|
| BARRIER: 80 mm Hg | BARRIER: 120 mm Hg | BARRIER: 160 mm Hg |
| Light/minimum BFE & PFE protection | High BFE & PFE protection | High BFE & PFE protection |
| Used for general procedures | More breathable than high | |
| and respiratory etiquette | barrier mask | |
| Designed to resist a splash or | Designed to resist a splash or | Highest fluid resistance - |
| spray at venous pressure | spray at arterial pressure | designed to resist a splash or |
| | | spray during tasks like |
| | | orthopaedic surgery or |
| | | trauma |

TABLE 2
ASTM F2100-11 (2011) REQUIREMENTS FOR MEDICAL FACE MASKS

| | LEVEL 1 (LOW) | LEVEL 2 (MODERATE) | LEVEL 3 (HIGH) |
|---|---|---|---|
| TEST | BARRIER: 80 mm Hg | BARRIER: 120 mm Hg | BARRIER: 160 mm Hg |
| BFE (Bacterial Filtration Efficiency) | ≥95% | ≥98% | ≥98% |
| at 3.0 micron ASTM F2101 | | | |
| PFE (Particulate Filtration Efficiency) | ≥95% | ≥98% | ≥98% |
| at 0.1 micron ASTM F2299 | | | |
| Delta P (Differential Pressure) | <4.0 | <5.0 | <5.0 |
| MIL-M-36954C, mm H2O/cm2 | | | |
| Fluid Resistance to Synthetic | 80 | 120 | 160 |
| Blood ASTM 1862, mm Hg | | | |
| Flame Spread 16 CFR part 1610 | Class 1 | Class 1 | Class 1 |

The term “Fluid resistance” reflects the surgical mask's ability to minimize the amount of fluid that could transfer from the outer layers through to the inner layer as the result of a splash or spray. ASTM specifies testing with synthetic blood at pressures of 80, 120, or 160 mm Hg to qualify for low, medium, or high fluid resistance. These pressures correlate to blood pressure: 80 mm Hg=venous pressure (Level 1), 120 mm Hg=arterial pressure (Level 2), and 160 mm Hg (Level 3) correlates to potential high pressures that may occur during trauma, or surgeries that include high pressure irrigation such as orthopedic procedures.

The term “Delta P” (Pressure Differential) measures the air flow resistance of the medical mask and is an objective measure of breathability. The Delta P is measured in units of mm H₂O/cm² and the lower the value the more breathable the mask feels. The ASTM standard requires that masks have a Delta P of less than 5.0 for moderate and high barrier masks, whereas low barrier masks must have a Delta P of less than 4.0.

The term “Flame Spread” indicates that all hospital masks must withstand exposure to a burning flame (within a specified distance) for three seconds. All priMED masks meet this requirement.

The conventional production process for personal protective equipment requires several machines and necessary logistics between them. Spunbond and meltblown production beams have very different characteristics. One difference is throughput, where the spunbond production beam typically provides several times higher throughput than the meltblown beam. From an economical point of view, it is advantageous to run the line at highest possible throughput and produce as much material as possible. Older SMS lines typically combined two or three spunbond beams with one to four meltblown beams. The spunbond/meltblown (SB/MB) ratio of such a line is much higher than that the ratio desired in personal protection equipment products. For example, an SMS line has an SB/MB ratio over 6; an SSMMMS line has an SB/MB ratio over 3. Newer line designs allow for an SB/MB ratio close to one and allow for testing of SM production as described herein. Surprisingly, it has been found that the online produced SM material has particularly preferred features, as described in detail below.

### BRIEF DESCRIPTION OF THE DRAWINGS

FIG. 1: Representative illustration of a nonwoven fabric according to the invention comprising the first spunbond layer (S) and the second meltblown layer (M)

FIG. 2: Representative illustration of pair of calander rollers 50; 51 with the fiber batt 21a passing through the nip 52 forming the nonwoven web 21.

FIG. 3: Representative illustration of a crossection of nonwoven fabric according to the invention showing the bonding impressions formed from the meltblown side of the fabric.

FIGS. 4A and B: Micrographs of a nonwoven fabric according to an exemplary embodiment of the present invention having bonding impressions of Ungricht pattern U2888, FIG. 4A from the M side, FIG. 4B from the S side.

FIG. 5: Representative illustration of a cross-section of nonwoven fabric according to an exemplary embodiment of the invention showing the bonding impressions formed from the spunbond side of the fabric.

FIG. 6: Representative illustration of a nonwoven fabric according to an exemplary embodiment of the invention comprising the first spunbond layer (S); the second meltblown layer (M) bonded together and the spunbond hydrophilic web (P) added from the M side.

FIG. 7: Representative illustration of a surface energy gradient of SMP fabric according to an exemplary embodiment of the invention

FIG. 8: A micrograph of a conventional SMS fabric structure

FIGS. 9A, 9B and 9C: Micrographs of an SM fabric structure according to an exemplary embodiment of the invention

FIG. 10: Chart showing the Air Permeability of meltblown layers as described in Table 3.

FIG. 11: Chart showing the Air permeability of comparative fabrics (Examples 2; 1A; 5; 1D; 6) and fabrics according to exemplary embodiments of the invention (Examples 3; 4; 7)

FIG. 12: Illustration showing a frontal perspective view of a face mask; and a back perspective view of the face mask.

### DETAILED DESCRIPTION

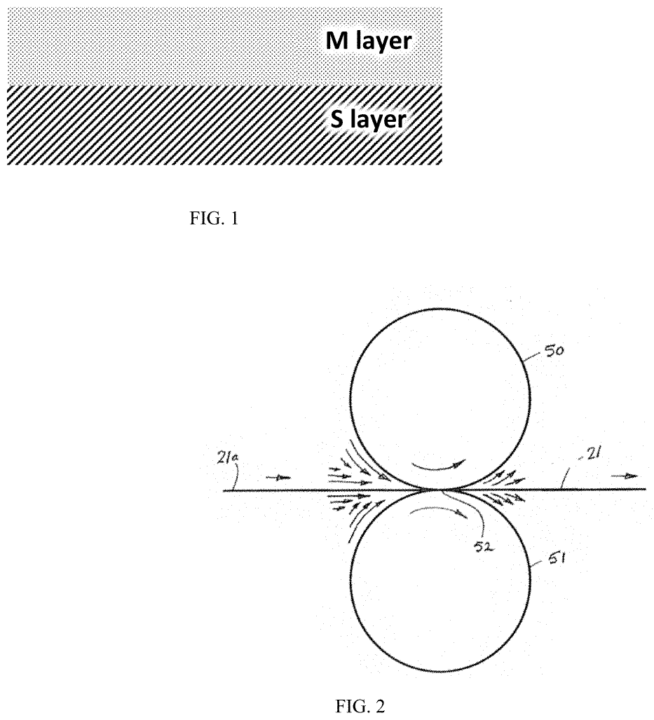

An object of the present invention is to provide a spunmelt nonwoven fabric made up of only a single spunbond layer disposed adjacent to a meltblown layer and which exhibits excellent filtration efficiency and breathability. As shown in FIG. 1, the first layer (S) of the inventive fabric is formed from spunbond fibres and the second layer (M) is formed from meltblown fibres. During the production process the spunbond fibres of the first layer (S) are deposited on a moving belt, forming a first batt (S*). The fibres of the second layer (M) are deposited on the first batt (S*) and the combination of layers continues to a bonding unit.

Objects of the present invention can be realized advantageously by means of thermal bonding of a spunbond batt (S*) with a meltblown layer (M) by a pair of calender rollers. As shown in FIG. 2, bond formation by calendering can be carried out in such a way that a fibre layer 21a passes through a nip 52 of a pair of rotating calender rollers 50, 51, thereby the fibres are compressed and consolidated bringing forth a nonwoven web 21. One or both calender rollers 50, 51 can be heated so that they support warming, plastic deformation, penetration and/or thermal melting/fusion of superimposed fibres in the process of their being compressed in the pressing nip. The rollers can constitute operational parts of a bonding mechanism, in which they are pressed together with a force of a controlled intensity so as to generate a required compressive force/required pressure in the pressing nip. In some processes a source of ultrasonic energy may be incorporated in the bonding mechanism to enable transmission of ultrasonic vibration into the yarns, thus generating a thermal energy in them, which improves bonding.

A bonding pattern, consisting of bonding protrusions and recessed areas, can be made using machining, etching, engraving or other technique on the circumferential surface of one or both calendering rollers 50, 51, thereupon the bonding pressure, having effect on the fibre layer passing through the pressing nip 52, is concentrated on bonding surfaces of the bonding protrusions, while it is decreased or substantially restricted in the recessed areas. The bonding surfaces have predetermined shapes. As a consequence of this, a nonwoven web 21 with a pattern consisting of bonding impressions 11, 13 among fibres, which form this nonwoven web 21, is formed, whereas the shape of these bonding impressions correspond to the shape of the bonding protrusions arranged in identical pattern on the surface of the calender roller 50, 51. One of the rollers, for example roller 51 can have a smooth cylindrical surface without any pattern and so it is the pressure or bearing roller, while the other roller 50 can be equipped with the pattern described above, and so it can be the roller creating the bonding pattern in the processed material; the pattern created on the nonwoven web by this combination of rollers will then exactly correspond to the pattern on the mentioned other roller 50. In some cases, both the rollers 50, 51 can be equipped with patterns, whereas these patterns can be the same or different from one another. In such a case a combined pattern is created on the nonwoven web by the effect of those patterns. Such a combined pattern is described, for example, in U.S. Pat. No. 5,370,764.

Without being bound by theory, it is believed that the pressure applied by the protrusions within the nip 52 pushes the meltblown layer (M) into the spunbond batt (S*) and forces the meltblown fibers to “squeeze” in between the spunbond batt fibers within the interface between the meltblown layer (M) and the spunbond batt (S*). It is further believed that this mechanism provides an important contribution to the overall performance enhancement of the fabric. In conventional SMS calendaring processes, the spunbond fibers protect the inner meltblown layer by absorbing the force generated by the protrusions on the rollers, allowing the meltblown to bend temporarily between the spunbond fibres and take back more or less its original form later. In contrast, the meltblown layer in the fabric according to the invention has no such protection and is therefore forced to remain within the interface between the layers in tight contact with the spunbond fibres. It is also believed that the same mechanism helps with the interspersing of the spunbond and meltblown fibers, thereby enhancing the fiber tortuosity and capillary action, while providing the fabric with a substantially high tensile strength compared to a conventional 100% meltblown-based filter layer.

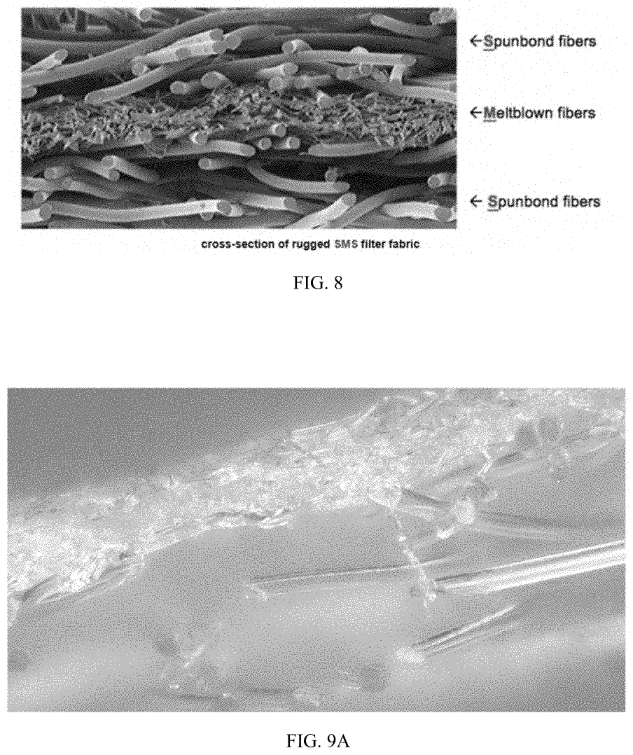

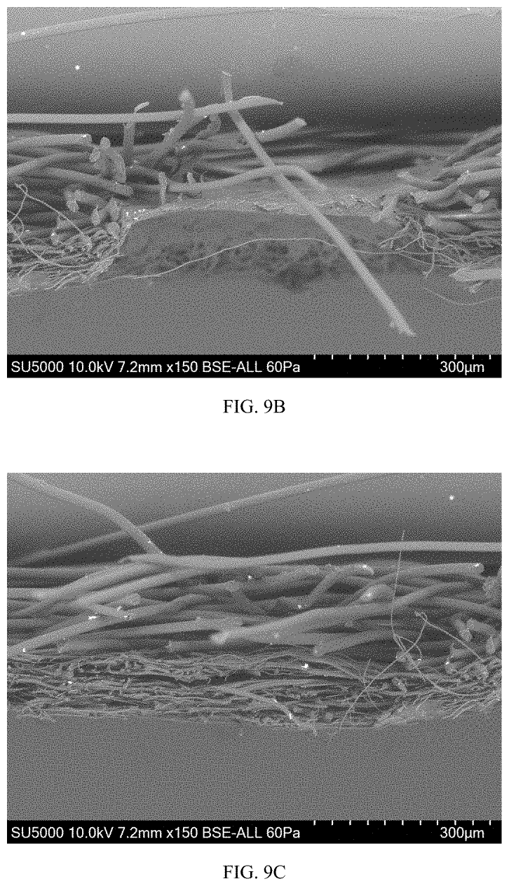

FIG. 8 is a micrograph of a conventional SMS fabric structure and FIGS. 9A, 9B and 9C are micrographs of an SM fabric structure according to an exemplary embodiment of the present invention. As shown in these figures, more meltblown fibers are present within the meltblown layer—spunbond layer interface of the SM fabric as compared to the interfaces within the SMS structure.

The fabric according to the invention provides two important properties which are balanced against one another to achieve maximized performance. First, the inventive fabric has a very good barrier property for micro particles (expressed by various filtration efficiencies, for example in the case of personal protective equipment, Bacterial Filtration Efficiency “BFE” or Submicron Particle Filtration Efficiency “PFE”, etc.). Second, the inventive fabric allows for flow of gas (air) through without too much resistance (expressed by various pressure drops—e.g. by Differential Pressure “delta P”).

The filtration efficiency can be understood as a function of fibre thickness (the finer the better), fabric bulkiness (the lower, the better) and fabric mass expressed for example by basis weight (for the same polymer density, the higher the better). Simply said, the narrower and longer pores in the fabric (higher tortuosity of pores), the better filtration efficiency.

The pressure drop expressing how much work is needed to push the gas through the filter can be also understood as a function of fibre thickness (the coarser the better=smaller pressure drop), fabric bulkiness (the higher, the better=smaller pressure drop) and fabric mass expressed for example by basis weight (for the same polymer density, the lower the better=smaller pressure drop). Simply said, the wider and shorter the pores in the fabric, the smaller pressure drop and the easier the gas flows through. If the work needed to push the gas (or other medium) through the fabric is too high, the weakest part of the barrier layer can break locally and the filtration efficiency is diminished.

Without being bound by theory, it is believed that the material according to exemplary embodiments of the present invention provides enhanced mechanical stability to the barrier meltblown layer due to the meltblown layer's (M) tight contact with and support by the spunbond layer (S) within the interface between the two layers. It is also believed that the common bonding of both layers improves the breathability of the material (i.e., decreases the pressure drop). In case of separate bonding of spunbond and meltblown layers, two sets of bonding impressions are present in the layers, which blocks the airflow inside the fabric. In contrast, the inventive material is formed with one set of bonding patterns, which allows the gas (air) flow to enter the fabric and fluently go through the long narrow irregular pores between spunbond and meltblown fibers. The filtration efficiency is not lowered while the breathability is enhanced with overall better mechanical integrity

In another exemplary embodiment, the single meltblown layer can be produced without calander bonding. At certain settings the produced meltblown fibers are able to bond together during their deposition on the moving belt or spunbond bonded web. Without being bound by theory, it is believed that in this exemplary embodiment breathability of the fabric is compromised due to the bonding impressions of spunbond layer blocking the air flow within the fabric.

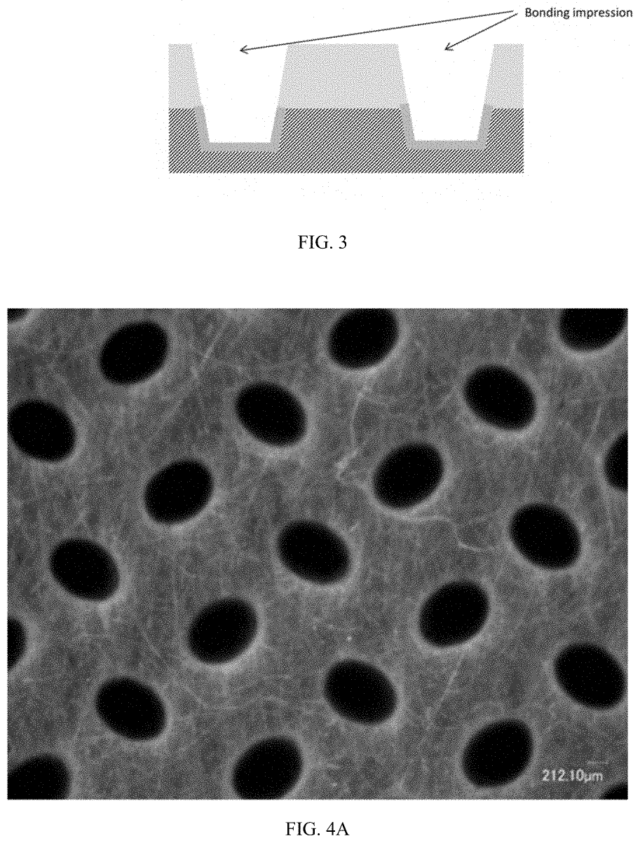

As shown in FIG. 3, in accordance with an exemplary embodiment of the present invention, during the calendering process, the first spunbond layer (S) faces and is in direct contact with the roll with a smooth cylindrical surface and the second meltblown layer (M) is facing and in direct contact with the roll with protrusions forming a pattern. Formed bonding impressions from the meltblown side of the fabric improves the fabric appearance from the M side. The material is then considered more engaging and pleasant to touch, so it might provide better comfort if being used as part of personal protective equipment with the M side facing the user's skin. On the contrary, if the second meltblown (M) layer faces and is in direct contact with the smooth roll, it has a tendency to flatten the surface. This results in too much of a slippery/plastic feel and is especially noticeable in an SM fabric where the melt blown side has in contrast to the spunbond side higher surface area (due to the many fine fibers in the meltblown layer versus coarser fibers in the spunbond layer). In an SMS fabric, this difference is not observed due to the outside layers being the same.

Without being bound by theory, it is believed that the bonding impressions from the meltblown layer side also improves the breathability of the material without losing the filtration efficiency. The meltblown layer is made up of very fine fibers and also the void volume among the fibers inside the fabric is very small and divided into many narrow irregular tortuous pores. The pressure drop within the layer is caused by several factors. One and most important is the size, shape and surface of the pores in the layer, that can be in general considered proportional to the filtration efficiency. It is believed that the second reason for the pressure drop is the manner by which the gas (air) is input to and interacts with the surface of the fabric. When the surface of the fabric is more open or larger—for example when the bonding impressions are from the meltblown side—the gas flow enters the barrier layer easier and the final breathability of the fabric is improved without losing the filtration efficiency.

Any of the first spunbond (S) and second meltblown (M) layer can be produced from one or more production beams with the same or differing production settings. For example, the first spunbond (S) layer can have an inner structure improving the filtration effect, as described for example in WO2016206659. For another example, the second meltblown (M) layer can have an inner structure improving the barrier function as described in WO2019222600 or WO2016206659.

In an exemplary embodiment the spunbond layer comprises fibers having an average thickness of 12 to 20 microns, preferably 12 to 18 microns, even more preferably 12 to 16 microns, and even more preferably 12 to 15 microns.

In an exemplary embodiment the spunmelt nonwoven fabric is produced from polyolefin, preferably from polypropylene resin (PP).

In an exemplary embodiment the nonwoven fabric comprises polyolefin with any combination of suitable additives, that can be in general divided into three groups:

A first group of additives focused on change of fabric appearance. For example, to change the opacity or the colour of the fabric. For example, the additive may comprise TiO₂. For example, the additive may comprise green, blue, pink, violet or any other colored pigment. In exemplary embodiments, additives may be used to change the fabric touch. For example, the additive may comprise erucamide to change the fabric touch more to silk-like. For example, the additive may comprise CaCO₃ to change the fabric touch more to dry feeling. For example, the additive can contain PP/PE copolymer (e.g. Vistamaxx from Exxon) to achieve a rubber-like feeling. For example, the additive can contain PP/PE copolymer to provide the fabric with higher pliability.

A second group of additives focused on change of surface function. Polyolefins are in general nonpolar polymers and their surface energy is very low, which is the reason for its very good filtration efficiency to polar substances, for example to the water-based drops or droplets, at even microscale. The negative capillary effect of nonpolar polyolefin pore surface in the barrier layer effectively prevents polar drops or droplets to enter or pass through the barrier layer. In the case of other types of microparticles with different surface characteristics, or in the case of specific particles having defined parts, it may be advantageous to change the nonpolar surface character using one or more functional additives. For example, an additive can form local spots with electric charge to catch the particles with opposite charge on them (e.g. magnesium stearate can be used for electric charge retention). For example, the additive can decrease the polyolefin surface energy to improve negative capillary effect against polar particles. For example, the additive can increase the surface energy locally to block also nonpolar substances more efficiently. For example, the additive can contain any “neutralizing” substance to exterminate the living particles in the barrier layer and prevent its growth through the barrier layer. For example, the additive can contain any substance with antiviral or antibacterial or fungicidal function. For example, the additive may contain nanoparticles of metals or metal substances (Cu, Ag, Au and many others). For example, the addition of high dielectric constant additives greatly improves the filtration efficiency of filter media mainly attributed due to an electrostatic capture mechanism. Such dielectric constant additives are known to increase the polarizability of electret fiber and enhance space charge formation over the fiber surface. For example, the additive may include a high dielectric constant additive such as barium titanate (BaTiO₃), magnesium stearate, tourmaline, etc. mixed into a polypropylene masterbatch. The resultant fabric produced with this additive is exposed to plasma or corona or any type of surface ionisation discharge at the manufacturer or at the convertor to further improve the filtration efficiency. It should be appreciated that any additive or additives may be added as appropriate to provide a desired function or combination of functions.

A third group of additives is focused on an efficient production process and may include any known process additive. Process additives are intended to improve the spinning quality or to smooth the process conditions. For example, metalocene polymer can be used, blended with standard polymer or added as an additive to improve spinning. For example, polymer with higher melt flow rate or slip additives can be used, such as, for example, CESA-slip from Clariant, L-MODU from Idemitsu, etc. For example, the additive might be focused on build-up prevention, such as, for example, Polyvel's Process Aids. For example, an additive might be used to improve the fiber resistance against local overheating during the calandering process, which can cause unwelcome burn-through. Other known or later-discovered process additives may be used to achieve desired results.

In exemplary embodiments the nonwoven fabric comprises bonding impressions formed in a regular pattern. The bond area percentage may be lower than 25%, preferably lower than 22%, preferably lower than 20%, and even more preferably lower than 18.5%, but at least 2%, more preferably at least 5%, more preferably at least 8% and even more preferably at least 10%.

In exemplary embodiments the nonwoven fabric comprises small bonding impressions with a size lower than 1 mm², preferably lower than 0.7 mm², preferably lower than 0.5 mm², and preferably lower than 0.4 mm², where size in this context means the surface area of the lowest part of the bonding impression or imprint. Without being bound by theory, it is believed that the relatively small size of the bonding impressions results in a larger number of imprint walls, which in turn improves breathability of the fabric without losing the filtration efficiency.

The bonding pattern can have regular distribution of bonding impressions but can also form for example visual effects (e.g., flowers, suns, text, etc.—some examples of which are described in WO2017190717) that result in a combination of larger and smaller imprints/bonding impressions in the nonwoven. In exemplary embodiments the nonwoven fabric has a bond area, wherein at least 50% of which is in the form of small bonding imprints with a size lower than 1 mm², preferably lower than 0.7 mm², preferably lower than 0.5 mm², and preferably lower than 0.4 mm², where size in this context means the surface area of the lowest part of the bonding impression or imprint, preferably at least 60% of the bonding imprints area is in the form of small bonding imprints as defined above, more preferably at least 70% is in the form of small bonding imprints as defined above, i.e. with the size defined in the above paragraph.

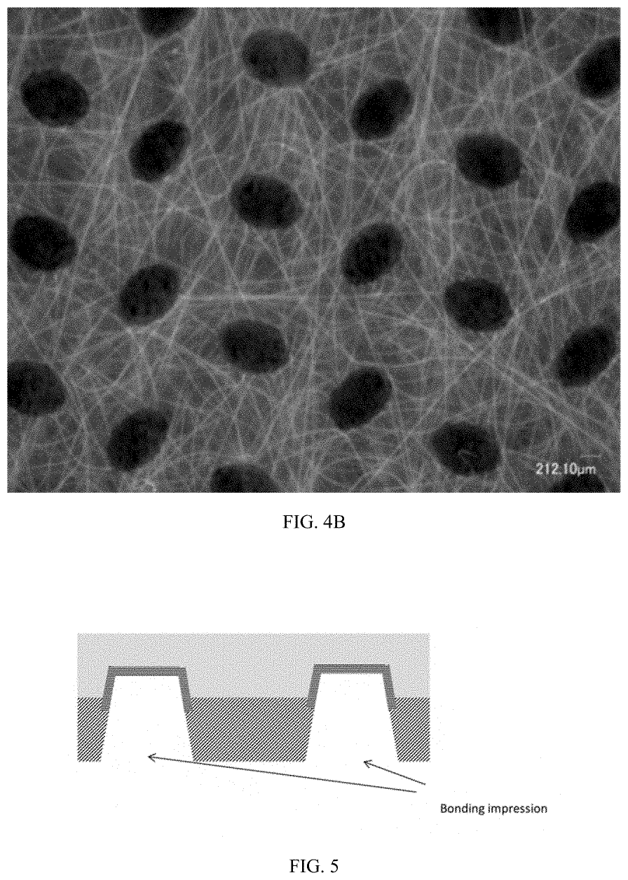

FIGS. 4A and 4B are micrographs of a nonwoven fabric according to an exemplary embodiment of the present invention having bonding impressions of Ungricht pattern U2888 with a bond area percentage of 18.1% and bonding impressions size of 0.363 mm², impressed to the fabric from the side of the MB layer. FIG. 4A shows the MB side of the fabric and FIG. 4B shows the SB side of the fabric. The micrographs illustrate the difference in spunbond and metlblown fiber size and structure. The black ovals are bonding impressions.

As shown in FIG. 5, in exemplary embodiments of the present invention, during the calendaring process, the spunbond layer (S) faces and is in direct contact with the roll with protrusions forming a pattern and the meltblown layer (M) faces and is in direct contact with the roll with smooth cylindrical surface. Due to the homogeneity of the smooth roll in contact with the meltblown layer surface, heat is constantly passed to the meltblown layer which prevents any inhomogeneities of the bonding in the meltblown layer. In contrast, if the meltblown (M) side of the fabric faces the roll with protrusions, the heat flow to the layer is locally irregular and the fabric may be exposed to higher thermal stress. Each protrusion presses the melblown layer more than the roller surface between the protrusions and the heat flows from all portions of the protrusion surfaces, including walls and edges, so the heat provided to the fibers at the border of bonding impressions is higher than the heat provided to the areas between bonding impressions. Disposing the meltblown (M) layer in facing relationship with the smooth roll provides the meltblown layer with improved homogeneity, which in turn can provide improved filtration efficiency. The spunbond layer (S) facing the protrusion forming pattern also provides advantages in fabric appearance. As the bonding impressions are formed from the side of thicker or coarser spunbond fibers, the fabric is in general less stiff and provides better pliability or softness. The bonding impressions and areas among them form a structure that is in general more pleasant to human touch than a smooth surface. Exposing the spunbond layer to the engraving roll also improves the aesthetics of the S layer while promoting the interspersing of the spunbond and meltblown fibers at the interface. In an exemplary embodiment of the present invention, the meltblown layer includes meltblown fibers that vary from one another in terms of thickness (so called broad fiber thickness distribution), so as to provide a structure that may be characterized as an inner supporting skeleton formed by thicker fibers, that is filled by a three-dimensional net of fine fibers including ultrafine fibers. This improves the mechanical stability of the layer, reducing compression under pressure and increasing the breathability of the fabric. At the same time the combination of thicker, fine and ultrafine fibers in the structure provides a high level of pore tortuosity and irregularity, which helps to achieve high level of filtration efficiency.

In an exemplary embodiment of the present invention, the meltblown layer includes two or more sublayers that differ in fiber structure. For example, the meltblown layer may include a first sublayer (C) of thicker fibers having an average fiber thickness in the range of 2-10 microns, preferably 3-6 microns, and a second sublayer (F) with at least 20%, preferably at least of 25%, more preferably at least 30%, even more preferably at least 35% of the fibers having a thickness below 1.5 microns, preferably below 1.3 microns, more preferably below 1.1 microns, and even more preferably below 1 micron. The combination of one or more C sublayers forming the bulkier structure with larger pores among fibers and one or more F sublayers with higher amount of fine and ultrafine fibers resulting in smaller pores among fibers provides great filtration efficiency in combination with improved breathability.

It should be appreciated that the nonwoven fabric according to exemplary embodiments of the present invention is not limited to any specific combination of sublayers, and examples of such combinations include CF, FC, FCF, FFC, FCFFCF, CFFFC and many others.

In an exemplary embodiment the meltblown layer of the nonwoven fabric has a basis weight of at least 5 gsm, preferably at least 7 gsm, preferably at least 9 gsm, preferably at least 11 gsm.

In an exemplary embodiment the meltblown layer of the nonwoven fabric has a maximum basis weight of 60 gsm, preferably 50 gsm, preferably 40 gsm, preferably 30 gsm, preferably 25 gsm, more preferably 20 gsm.

In an exemplary embodiment the meltblown layer of the nonwoven fabric has a basis weight within the range 7 to 30 gsm, preferably 7 to 25 gsm, preferably 9 to 20 gsm, preferably 11 to 20 gsm.

In an exemplary embodiment the spunbond layer of the SM nonwoven fabric has a basis weight of at least 5 gsm, preferably at least 7 gsm, preferably at least 9 gsm, preferably at least 11 gsm.

In an exemplary embodiment the spunbond layer of the SM nonwoven fabric has a maximum basis weight of 60 gsm, preferably 55 gsm, preferably 45 gsm, preferably 35 gsm, preferably 30 gsm, preferably 25 gsm, preferably 20 gsm, more preferably 15 gsm.

In an exemplary embodiment the spunbond layer to meltblown layer basis weight ratio of the SM nonwoven fabric is in a range of 0.5-1.5, preferably 0.6-1.4, preferably 0.7-1.3, preferably 0.8-1.2, more preferably 0.9-1.1.

In an exemplary embodiment the SM nonwoven fabric has a BFE (Bacterial Filtration Efficiency) higher than 80%, preferably higher than 85%, preferably higher than 90%, preferably higher than 95%, more preferably higher than 98%.

In an exemplary embodiment the SM nonwoven fabric has a PFE (Particle Filtration Efficiency) higher than 80%, preferably higher than 85%, preferably higher than 90%, preferably higher than 95%, more preferably higher than 98%.

In an exemplary embodiment the SM nonwoven fabric has a hydrohead of at least 20 mbar, preferably of at least 25 mbar, preferably of at least 30 mbar, preferably of at least 35 mbar, more preferably at least 40 mbar.

In an exemplary embodiment the SM nonwoven fabric is intended for use in contact with or very close to the human body (e.g. face mask, protective clothing, gloves, etc). In such a case all barrier and breathability requirements need be fulfilled and also the comfort of the person should be considered—for example softness (including proper thickness, bulkiness, compressibility etc.), pleasant touch of the fabric or its drapability (can be expressed for example by HOM).

In an exemplary embodiment the SM nonwoven fabric has an HOM (Handle-O-Meter) value lower than 50 g, preferably lower than 45 g, preferably lower than 40 g, preferably lower than 35 g, more preferably lower than 30 g, where HOM in this context is the average of the CD and MD values.

In an exemplary embodiment the SM nonwoven fabric has a thickness in the range of 0.10 to 0.60 mm, preferably 0.10 to 0.50 mm, preferably 0.10 to 0.40 mm, preferably 0.10 to 0.35 mm, more preferably 0.15 to 0.35 mm.

The breathability of the fabric can be expressed by many parameters—for example by air permeability or by Delta P or other method of pressure drop measurement. Each industry with its specific condition tends to adhere to a different measurement. The measurement methods do not provide comparable results and it cannot be predicted how the differently measured values would correlate. Air Permeability measures the volume of air passing through a defined area of fabric for a defined time and defined pressure. In contrast, pressure drop (Delta P) measures how much work (W) needs to be done to push a defined volume of air through the fabric. For example, the performance of face masks is measured using pressure drop (the lower the better), while performance of protective garments are measured in view of Air Permeability to provide both user comfort and protection. Without being bound by theory, it is believed that air permeability can approximately predict the desired combination of pressure drop and filtration efficiency, with lower values (e.g., 30-40 cfm) being more desirable than higher values. In general, very low values for air permeability are not desirable for face mask applications, but are more appropriate for other applications, where a higher barrier function is desired.

In an exemplary embodiment the nonwoven fabric has an air permeability higher than 20 cfm, preferably higher than 25 cfm, preferably higher than 30 cfm, preferably higher than 35 cfm, more preferably higher than 40 cfm.

In an exemplary embodiment the nonwoven fabric has a Delta P (differential pressure) lower than 10.0, preferably lower than 8.0, preferably lower than 6.0, preferably lower than 5.0, preferably lower than 4.5, preferably lower than 4.0, more preferably lower than 3.5.

In an exemplary embodiment the nonwoven fabric has a high nGMT (normalized geometrical mean of CD and MD tensile strength), which may be determined in accordance with the following formula:

$$nGMT = \frac{\sqrt[2]{( CD tensile ( \frac{g}{cm} ) ) * ( MD tensile ( \frac{g}{cm} ) )}}{basis weight ( g \text{/} {m}^{2} )} \qquad ( 1 )$$

In an exemplary embodiment the nonwoven fabric has an nGMT value of higher than or equal to 15, preferably higher than or equal to 17, and more preferably higher than or equal to 19.

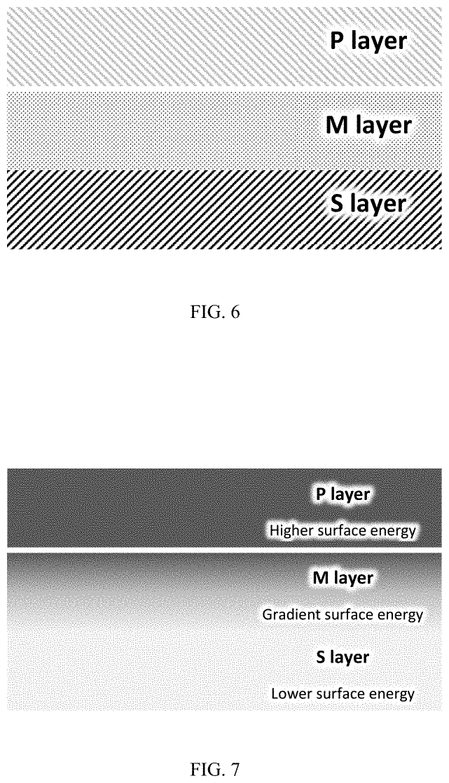

As shown in FIG. 6, in an exemplary embodiment according to the invention the SM fabric is combined with a spunbond hydrophilic web (P) so that the spunbond hydrophilic web (P) is facing and in direct contact with the meltblown layer (M) in the SM fabric, thereby forming together an SMP structure.

In an exemplary embodiment according to the invention the gradient fabric (SM) and the spunbond web (P) are not bonded together across their entire surfaces (e.g., by glue or calender with a relatively small regular pattern as described above). Instead, the two layers can be connected to one another via ultrasonic bonding or other similar bonding techniques more in a manner of sewing the pieces together to form the final product. For example, the layers may be connected at the edges. As another example, the layers may be connected by fused areas at defined distances. The working filtration area preferably does not contain any or contains a very limited amount of fused parts. For example, the fused portions can be located only at the filter edges. For example, the layers can be fused at defined points according to the face mask construction.

In an exemplary embodiment of the invention the spunbond hydrophilic layer contains a hydrophilic additive that is able to migrate slightly into the adjacent surface area of the meltblown layer. The migration can be driven for example by gas (air) flow, by wet flow (e.g., in form of droplets), by temperature (working temperature, user body temperature), etc. A suitable additive for this purpose can be for example a spin finish treatment applied by kiss-roll or spray and dried. Examples of suitable hydrophilic additives includes for example Silastol PHP 90 or PST-N from Schill & Silacher GmbH, Boblingen, Germany or S6327 from Pulcra Chemicals.

As shown in FIG. 7, the inventive SMP structure includes an M-P interface area, with the fibers of the hydrophilized spunbond web P with surface energy in a range of 50 to 60 mN/m laying adjacent to the meltblown fibers with much lower surface energy. For example, the untreated polypropylene in the meltblown layer has a surface energy of approximately 30 mN/m. The ability of the hydrophilic additive to migrate from the P fibers to the M fibers is limited by the absence of regular small bonding impressions across the entire structure. The migration can take place only when the M and P fibres are pressed tightly to each other by external influences (for example by gas flow during use). Under such conditions, the hydrophilic additive is not able to penetrate the second meltblown layer fully, but is able to create a surface energy gradient in it. The meltblown M fibers touching the spunbond P fibers have a surface energy close to that of the P fibers surface energy range, with the surface energy decreasing to the non-hydrophilized levels within the meltblown layer as distance increases from the interface between the M and P layers. The surface energy gradient through the second meltblown layer improves the filtration efficiency. The particles with low surface energy are more efficiently stopped by the higher surface energy portion of the meltblown layer and the particles with higher surface energy are more efficiently stopped by the lower surface energy portion of the meltblown layer. The improved efficiency of blocking particles with different surface energy also supports better breathability of the fabric without losing the desired filtration efficiency.

In an exemplary embodiment the SMP nonwoven fabric has a BFE (Bacterial Filtration Efficiency) higher than 80%, preferably higher than 85%, preferably higher than 90%, preferably higher than 95%, more preferably higher than 98%.

In an exemplary embodiment the SMP nonwoven fabric has a PFE (Particle Filtration Efficiency) higher than 80%, preferably higher than 85%, preferably higher than 90%, preferably higher than 95%, more preferably higher than 98%.

Apart from online produced SMS fabric with one spunbond hydrophilised, the SMP material according to the invention has two important advantages. First, the meltblown fibers of the second layer are interspersed with the spunbond fibers of the first layer. Second, the M-P contact is limited as the layers are not bonded together by calender bonding. The bonding impressions, where all layers are compressed and exposed to heat, are not present and thus do not support the hydrophilic additive migration to the melblown layer, which can otherwise cause a higher level of additive migration into the meltblown layer in and close to the bonding points, decreasing the mass of low surface energy fibers in these areas, which in turn can decrease the filtration efficiency.

In exemplary embodiments, SM and SMP nonwoven fabrics can be used in a product on their own, or in combination with any other fabric or other material suitable for specific applications. For example, one or more SM or SMP structured may be used in a product (e.g., SM-MS; SM-SM; PMS-SMP; SMP-PSM; SMP-SMP etc). In other exemplary embodiments, SM and SMP fabrics may be used with one another to form structures such as SMP-MS. In exemplary embodiments, SM and SMP fabrics can be used in combination with other spunbond or meltblown or spunmelt fabrics. Examples of such structures include S-SM; SM-S; S-SM-M-SM-S, etc. In exemplary embodiments, SM and SMP fabrics can be used in combination with any type of nonwoven, fabric, foam or any other type of material. It should be appreciated that the manner in which the inventive SM and SMP fabrics may be used in combination with other materials is not limited to the examples provided herein.

In accordance with exemplary embodiments of the present invention, during the production process the polymer resin is melted in an extrusion system, and provided through the filtration system to the production beam, where the fibers are formed, cooled, drawn and deposited on the moving collection belt forming the batt 21a.

The spunbond fibers of layer (S) are produced of a spunbond grade of polymer resin. The spunbond fibers are preferably made of polyolefin, and in a preferred embodiment are made of polypropylene.

The Melt Flow Rate of the spunbond grade can be in a range of 15-50 g/10 min, preferably in a range of 20-40 g/10 min.

The spunbond fiber polymer composition can contain any suitable additives. For example, the polymer composition can contain CaCO₃ and/or copolymer PP/PE and/or soft enhanced additive (e.g., erucamide) and/or colour additive (based on TiO₂ or suitable organic or inorganic substances), etc.

The spunbond layer can be produced from one or more production beams following each other, having the same or differing polymer compositions and process settings.

In an exemplary embodiment of the invention the spunbond production beams are preferably ran at below ¾ of standard throughput production range, more preferably below half of standard throughput production range, even more preferably below ¼ of standard throughput production range. For example, for the high throughput REICOFIL 4 line with the standard production range from 180 kg/h/m to 270 kg/h/m it may be advantageous when the spunbond throughput is lower than 245 kg/h/m, more preferably lower than 225 kg/h/m, even more preferably below 200 kg/h/m.

The spunbond fibers are deposited on the moving belt, forming the first batt (S*).

The meltblown fibers are produced of meltblown grade of polymer resin. The meltblown fibers are preferably made of polyolefin, and in a preferred embodiment are made of polypropylene.

The spunbond layer can be produced from one or more production beams following each other, having the same or differing polymer compositions and process settings.

The Melt Flow Rate of the meltblown grade can be in a range of 500-2000 g/10 min

In an exemplary embodiment of the invention the Melt Flow Rate of meltblown grade is within a range of 1000-2000 g/10 min, preferably 1200-1750 g/10 min. Such ranges provide finer meltblown fibers. In the case of narrow fiber thickness distribution the average fiber thickness is lower and so the fabric has narrower irregular tortuous pores, which provides improved filtration efficiency compared to the lower melt flow rate polymers. In the case of broad fiber thickness distribution the high melt flow rate polymers provides a portion of ultra-fine fibers, for example in the submicron range, which improves both breathability and filtration efficiency.

In an exemplary embodiment of the invention the meltblown layer is produced from multiple meltblown production beams with differing polymer compositions. For example, production beams that produce fibers from the melblown grade at a Melt Flow Rate in the range of 1000-2000 g/10 min, preferably 1200-1750 g/10 min can be combined with production beams that produce fibers from the melblown grade at a Melt Flow Rate in the range of 400-1000 g/10 min, preferably 500-800 g/10 min. The lower Melt Flow rate leads to thicker meltblown fibers forming the bulkier structure with larger pores among fibers. In contrast, the higher Melt Flow Rate leads to at least some fine and ultrafine fibers with lower bulkiness and smaller pores among fibers. The combination of such sublayers in the meltblown layer provides high filtration efficiency in combination with improved breathability.

The fibers of the second layer (M) are deposited on the first batt (S*) and together the layers continue to the bonding unit.

Objects of the present invention can be realized by thermal bonding of the spunbond batt (S*) with the meltblown layer (M) by a pair of calender rollers. As shown in FIG. 1, bonds formed by calendering can be carried out in such a way that the fiber layer 21a passes through a nip of a pair of rotating calender rollers 50, 51, thereby the fibers are compressed and consolidated bringing forth a nonwoven web 21. One or both calender rollers 50, 51 can be heated so that they support warming, plastic deformation, penetration and/or thermal melting/fusion of superimposed fibres while the fibers are compressed in the pressing nip. The rollers can constitute operational parts of a bonding mechanism, in which they are pressed together with a force of a controlled intensity so as to generate a required compressive force/required pressure in the pressing nip, forming the gradient fabric (SM)

In an exemplary embodiment according to the invention where the roll with a smooth cylinder surface faces and is in direct contact with the spunbond layer, the calender rollers 50, 51 are heated to a range 148° C.-152° C. In an exemplary embodiment according to the invention where the roll with a smooth cylinder surface faces and is in direct contact with the spunbond layer, the calender roller with protrusions is heated to a maximum of 152° C.

In an exemplary embodiment according to the invention where the roll with a smooth cylinder surface faces and is in directed contact with the meltblown layer, the calender roller with protrusions can be heated to a range of 148° C.-162° C. and the roller with a smooth cylinder surface can be heated to a maximum at 152° C.

In exemplary embodiments, calender temperatures may be varied for different production lines. The inventive SM product is preferably bonded at a temperature that is at least 2° C., preferably 5° C. lower than the standard bonding temperature for SMS fabric at the same or similar line speed and basis weight. The inventive SM product is preferably bonded at a temperature that is not lower than 10° C., preferably not lower than 8° C. than the standard bonding temperature for SMS fabric at the same or similar line speed and basis weight.

In an exemplary embodiment, protrusions shapes on the calender roll are designed to reduce the risk of burn-through.

In an exemplary embodiment according to the invention, the nip pressure is preferably higher than 75 daN/cm (decaNewton/centimeter), preferably higher than 80 daN/cm.

In an exemplary embodiment according to the invention, the nip pressure is preferably lower than 100 daN/cm, and preferably lower than 95 daN/cm, and more preferably lower than 90 daN/cm.

In an exemplary embodiment according to the invention, the nip pressure is preferably in a range of 75 to 95 daN/cm.

The online production of the inventive SM fabric provides advantages in terms of cost and efficiency. The final SM material is produced from polymer pellets and is ready to use on one line in one production step. There is no extra cost for handling the semi-finished product (e.g., spunbond and meltblown produced independently and then bonded together).

In an exemplary embodiment of the invention a spunbond layer (P) is produced separately from the SM structure. The polymer resin is melted in extrusion system, provided through the filtration system to the production beam, where the fibers are formed, cooled, drawn and deposited on the moving collection belt forming the batt.

The spunbond fibres of the layer (P) may be produced of a spunbond grade of polymer resin. In a preferred embodiment, the layer (P) is made of polyolefin, preferably polypropylene.

The Melt Flow Rate of the spunbond grade used to form the spunbond layer (P) can be in a range of 15-50 g/10 min, preferably in a range of 20-40 g/10 min.

The spunbond fiber polymer composition may contain any suitable additives. For example, the polymer composition can contain CaCO₃ and/or copolymer PP/PE and/or softness enhancing additive (e.g. erucamide) and/or color additive (based on TiO₂ or suitable organic or inorganic substances) and/or charge enhancing dielectric additives such as barium titanate or magnesium stearate, etc.

The spunbond layer can be produced from one or more production beams following each other, having the same or differing polymer compositions and process settings.

The spunbond fibers are deposited on the moving belt, forming the batt (P*) and provided to the bonding unit as described for the first spunbond web in the SM structure.

In an exemplary embodiment according to the invention the spunbond batt (P*) is bonded by the calender rollers 50, 51 heated in a range 148° C.-162° C., forming the spunbond web (P).

In an exemplary embodiment according to the invention, the nip pressure is in a range of 75 to 100 daN/cm.

In an exemplary embodiment according to the invention the spunbond web P is combined with gradient fabric (SM) so that the third spunbond web P is facing and in direct contact with the meltblown layer (M) in the SM fabric, forming together an SMP structure. The gradient fabric (SM) and the spunbond web (P) are not bonded together across their entire surfaces (e.g. by calender with small regular patterns as described for bonding of gradient fabric (SM)), but instead may be bonded by spaced-apart fused areas. The filtration area does not contain or contains a very limited amount of fused parts. For example, when forming filter, they can be fused at the filter edges only. For example, when forming face mask, they can be fused at defined points according to the face mask construction.

### Examples

In the following examples of SM nonwoven web manufacturing processes according to exemplary embodiments of the present invention (if not stated differently), the spunbond batt (S*) and meltblown fiber layer (M) were produced using REICOFIL technology. The spunbond batt (S*) was produced from one spunbond-type beam from spunbond grade polypropylene with an MFR of 35 g/10 min and the meltblown fiber layer (M) was produced from multiple meltblown-type beams arranged one after the other from meltblown grade polypropylene with a MFR in a range of 1200-1500 g/10 min.

Two different bonding procedures A and B were used as follows:

Procedure A, used in the Comparative Examples, was a three-step process, where the spunbond layer (S) and the meltblown layer (M) were produced and separately bonded by a pair of calender rollers (=step one and two). In step three, the S and M layers were placed next to each other and bonded or fused together.

Procedure B, used in Examples in accordance with the present invention, was a one-step process, where the spunbond batt (S*) was deposited on the moving belt. Meltblown fibers (M) were deposited on the spunbond batt (S*) and were bonded together by a pair of calander rolls.

Comparative Examples 1A to 1H were produced on a meltblown production line, with Comparative Examples 1A to 1G using two meltblown beams and Comparative Example 1H using four metlblown beams. A meltblown grade polypropylene with a MFR of 1200 g/10 min was used for all Comparative Examples 1A to 1H.

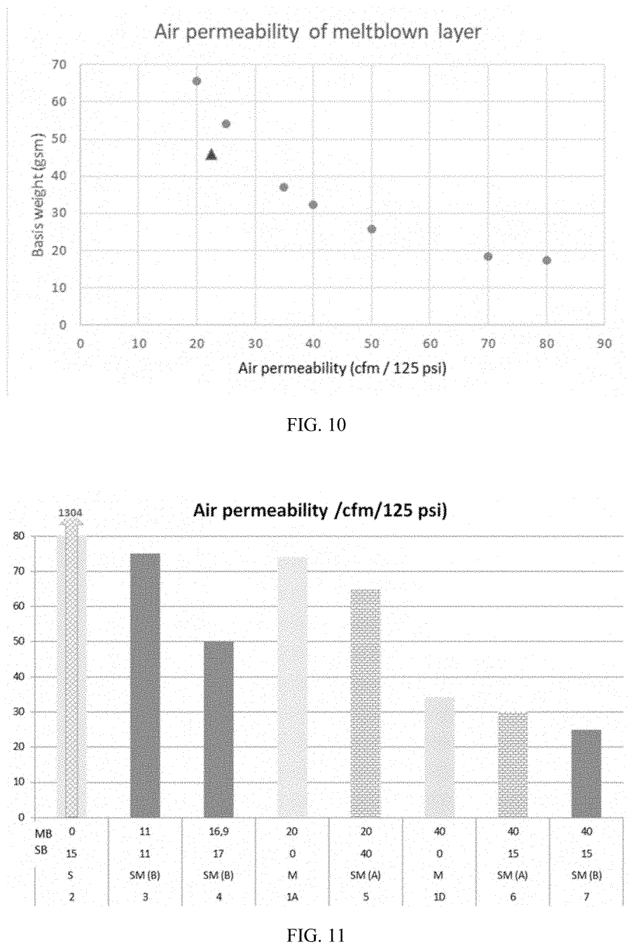

As shown in the chart of FIG. 10 and Table 3 below, with increasing basis weight of meltblown, the breathability of the material decreases at a predictable rate (Comparative Examples 1A-G). The production settings also affected the air permeability level as evidenced by Comparative Example 1H, which involved use of four production beams instead of two. Similarly, with increasing basis weight of meltblown, the filtration efficiency increases.

As discussed, meltblown layers are often used as filtration material or as a barrier/filtration layer in personal protection equipment. For example, the North® surgical mask from Honeywell (Honeywell, Charlotte, N.C., USA) contains a meltblown layer in between two spunbond layers. All three layers are bonded independently and then the laminate is created. The inner MB layer has a basis weight of approximately 20 gsm and an air permeability of 74 cfm.

TABLE 3

| (Comparative) | Basis weight of | Air permeabilty | Number of MB |
|---|---|---|---|
| Example 1 | Meltblown (gsm) | (cfm/125 psi) | production beams |
| A | 20 | 66 | 2 beams |
| B | 25 | 54 | 2 beams |
| C | 35 | 37 | 2 beams |
| D | 40 | 32 | 2 beams |
| E | 50 | 26 | 2 beams |
| F | 70 | 19 | 2 beams |
| G | 80 | 17 | 2 beams |
| H | 23 | 46 | 4 beams |

Comparative Example 2 was produced by a spunbond beam from a spunbond-type of polymer with a basis weight 15 gsm. The spunbond beam had a throughput of 240 kg/h/m. The produced nonwoven batt was calender bonded using a small regular pattern known as oval pattern (Ungricht type U2888).

Examples 3, 4 and 7 according to the invention were produced online in one production step on a spunmelt production line of the type Reicofil 4. Spunbond batt S* was produced by one spunbond beam from a spunbond-type of polypropylene. Meltblown fibers were deposited on the S* batt from four meltblown production beams placed one after the other. The S*M batt was bonded by a pair of calander rolls heated to 150° C. with a nip pressure of 85 daN/cm using a small regular pattern known as oval pattern (Ungricht type U2888). The basis weight of the spunbond and meltblown layers is provided in Table 4.

Comparative Examples 5 and 6 were produced offline in three steps, where first the spunbond web was produced from a spunbond polymer-type and bonded, separately as an individual second step the melblown layer was produced and bonded, and then in a third step both layers were bonded together. The basis weight of the spunbond and meltblown layers is provided in Table 4.

TABLE 4

| | | | | Air |
|---|---|---|---|---|
| | Fabric | BW SB | BW MB | Permeability |
| Example | Structure | (gsm) | (gsm) | (cfm/125 psi) |
| (Comparative) | S | 15 | 0 | 1304 |
| Example 2 | | | | |
| Example 3 | SM (B) | 11 | 11 | 75 |
| Example 4 | SM (B) | 17 | 17 | 50 |
| (Comparative) | SM (A) | 40 | 20 | 64.7 |
| Example 5 | | | | |
| (Comparative) | SM (A) | 15 | 40 | 30 |
| Example 6 | | | | |
| Example 7 | SM (B) | 15 | 40 | 25 |

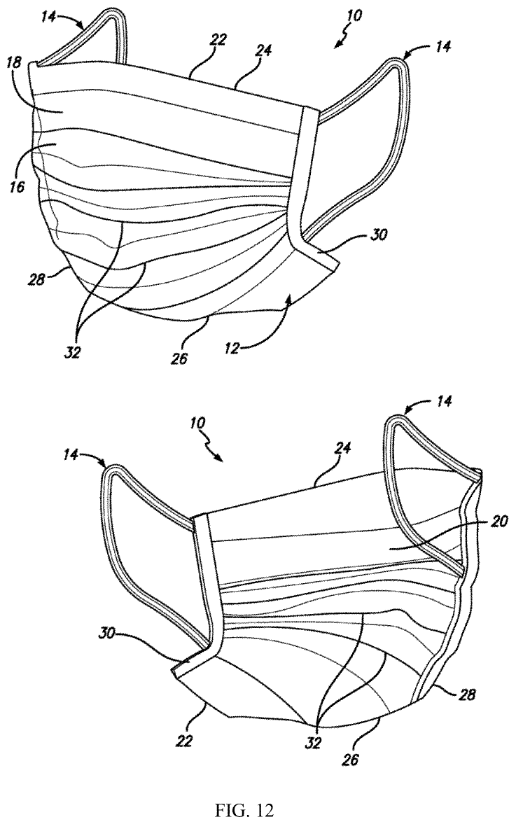

Example 2 is a comparative sample showing the breathability level of spunbond, itself (i.e., no meltblown). It can be seen that the air permeability level is over 1000 cfm, in contrast to the air permeability level of all SM Examples which are below 100 cfm. Specifically, Examples 3-7 include a meltblown layer in the fabric, with the basis weight reaching 40 gsm in Examples 6 and 7. Air permeability data corresponding to Examples 2, 3, 4, 1A, 5, 1D, 6 and 7 is graphed in FIG. 11 for ease of comparison.

Air permeability of the Examples according to the invention is generally lower than that of comparative Examples. For example, offline produced SM structures (Example 5) with 20 gsm of meltblown fibers provides higher air permeability as compared to that of online produced SM structures according to the invention (Example 3), where the mass of meltblown fibers is much lower (11 gsm) in the inventive SM product. A similar effect can be seen also at higher MB content in comparative Example 6 and Example 7 (which have the same amount of SB and MB content), where the air permeability of Example 7 produced according to the invention is lower in comparison. The generally lower air permeability of the inventive Examples demonstrates that the SM structure according to exemplary embodiments of the present invention are particularly suited for use in face masks and respirators, since as explained previously the lower air permeability may be correlated with a good balance between pressure drop and filter efficiency.

Filtration efficiency and breathability of the protective material are important features, but wearer comfort is also relevant for overall filter performance. In this regard, Table 5 provides tensile strength, elongation, hydrohead, stiffness (HOM) and thickness of the fabric according to the Examples 3, 4 and 1H.

TABLE 5

| Example | 3 | 4 | 1H |
|---|---|---|---|
| MB (gsm) | 11 | 17 | 22.3 |
| SB (gsm) | 11 | 17 | 0 |
| total (gsm) | 22 | 33.2 | 23 |
| MDT (g/cm) | 610 | 920 | 355 |
| MDE % | 48 | 51 | 46 |
| CDT (g/cm) | 285 | 500 | 240 |
| CDE % | 52 | 60 | 65 |
| nGMT | 19.0 | 20.4 | 13.1 |
| Hydrohead, mbar | 49 | 71 | — |
| MD HOM, g | 1.8 | 03.8 | — |
| CD HOM, g | 06.2 | 17.1 | — |
| Thickness (mm) | 0.2 | 0.3 | 0.20 |

TABLE 6

| TEST | Example 3 | Example 4 |
|---|---|---|
| BFE (Bacterial Filtration Efficiency) | 95.41% | 98.28% |
| at 3.0 micron ASTM F2101 | | |
| PFE (Particulate Filtration Efficiency) | 95.13% | 98.52% |
| at 0.1 micron ASTM F2299 | | |
| Delta P (Differential Pressure) | 1.73 | 2.18 |
| MIL-M-36954C, mm H2O/cm2 | | |

As shown in Table 6, Example 4 passed barrier and Differential Pressure requirements for Level 3 (high) masks according to the ASTM F2100-11 (2011) REQUIREMENTS FOR MEDICAL FACE MASKS.

Example 8 is a comparative example taken from a product on the market—Surgical Mask, Nose Clip No, Blue, Mask Size Universal, PK 50 from Honeywell. The product was produced offline S-M-P. All three layers have separate visible bonding patterns.

Examples 9 and 10 according to the invention are made up of an SM part and a P part. The SM portion was produced online on a REICOFILE 4-type production line with one spunbond followed by four meltblown beams. The fabric was then bonded The line settings are provided in Table 7. The S*M batt was bonded by a pair of calender rolls heated to 150° C. with a nip pressure of 85 daN/cm using a small regular pattern known as oval pattern (Ungricht type U2888). The P portion was produced separately on a REICOFIL 4 type production line from spunbond polymer, bonded by pair of calander rolls using a small regular pattern known as oval pattern (Ungricht type U2888) and treated by spinfinish S6327 from Pulcra Chemicals. Material composition and process settings are provided in Table 7.

TABLE 7

| Example | 8 | 9 | 10 |
|---|---|---|---|
| fabric type | S-M-P | SM-P | SM-P |
| S basis weight | 18 | 11 | 17 |
| M basis weight | 21 | 11 | 17 |
| P basis weight | 24 | 20 | 15 |
| Meltblown composition | — | MMMM | MMMM |
| MB polymer | — | Exxon type | Exxon type |
| | | 6936 | 6936 |
| MB throughput (kg/h/m) | — | 80 | 80 |
| BFE | Pass | 95.36% | 98.56% |
| PFE | Pass | 95.22% | 98.41% |
| Delta P | Pass | 1.79 | 2.34 |
| Fluid Resistance to | Pass | 0 | 0 |
| Synthetic Blood | | | |

As shown in Table 7, Examples 9 and 10 passed barrier and Differential Pressure requirements for Level 3 (high) masks according to the ASTM F2100-11 (2011) REQUIREMENTS FOR MEDICAL FACE MASKS.

Testing Methodologies:

The “Basis weight” or “BW” of a nonwoven web is measured according to the European standard test EN ISO 9073-1:1989 (conforms to WSP 130.1). There are 10 nonwoven web layers used for measurement, sample size 10×10 cm². In case of layered product, the layers are at first delaminated and then measured independently. Or the basis weight value is taken from production line settings.

The “Tensile strength” measurement is performed in accordance with ASTM methods, more specifically ASTM5034, using an Instron test machine. Measurement is done in both MD and CD directions, respectively. CD tensile strength “CDT” in lb/in and elongation “CDE” in percentage %; MD tensile strength “MDT” in lb/in and elongation “MDE” in percentage %. Both CDT and MDT values can be also expressed as g/cm using the ratio 1 gm/cm=0.00559974 lbs/in for recalculation.

The “Water column (mbar)” or “Hydrohead” is measured on nonwoven textiles using the standardised testing methodology WSP 080.6.R4 (12) issued by the European Disposables and Nonwovens Association (EDANA). A 100 cm² head is used with a fluid pressure increase rate of 10 mm water column/minute. Unless indicated otherwise, clean water was used for the measurement.

The Handle-O-Meter (HOM) stiffness of nonwoven materials is performed in accordance with WSP test method 90.3 with a slight modification. The quality of “hand” is considered to be the combination of resistance due to the surface friction and flexural rigidity of a sheet material. The equipment used for this test method is available from Thwing Albert Instrument Co. In this test method, a 100×100 mm sample was used for the HOM measurement and the final readings obtained were reported “as is” in grams instead of doubling the readings per the WSP test method 90.3. When measuring the SM fabric, the S side was facing the desk of the measurement device. Average HOM was obtained by taking the average of MD and CD HOM values. Typically, the lower the HOM values the higher the softness and flexibility, while higher HOM values mean lower softness and flexibility of the nonwoven fabric.

The “Caliper” or “Thickness” of the nonwoven material is measured according to the European standard test EN ISO 9073-2:1995 (conforms to WSP 120.6) with the following modification:

1. The material was measured on a sample taken from production without being exposed to higher strength forces or spending more than a day under pressure (for example on a product roll), otherwise before measurement the material has to lie freely on a surface for at least 24 hours.

2. The overall weight of the upper arm of the machine including added weight is 130 g.

The “Air Permeability” or “AirPerm” of the nonwoven material is measured according to the standardised testing methodology WSP 070.1 issued by the European Disposables and Nonwovens Association (EDANA). The Air permeability value is measured in cfm (cubic foot per minute) under the pressure 125 psi (pound per square inch) and orifice 38 cm².

The “Fiber thickness” is expressed in microns (micrometers). It is possible to use, for example, an optical or electronic microscope (depending on the diameter of the measured fibres). At least 50 individual fibers were measured to calculate the average value.

SM fabric according to the invention can be used as a filtration medium itself, or in combination with other materials. For example, a reusable cotton face mask or other type of personal protective equipment can be provided with a pocket in between cotton layers, and a piece of disposable SM fabric can be inserted between the layers to improve the protection level of the personal protective equipment. In another example, the inventive SM fabric may be an integral component of a face mask so that the face mask has a unitary construction made entirely of the SM fabric (other than the elastics or other components used to fasten the face mask on the wearer).

The inventive composite SMP can be used as a filtration medium. For example, the inventive composite SMP can be used for gas (air) filtration and/or it can be used as a filtering component of personal protective equipment, such as, for example, a face mask.

Both the inventive SM and SMP fabric can be used as a barrier layer in various applications, such as, disposable hygienic products, medical care products (pads, covers etc.), industrial applications (e.g., air conditioning filtration), etc.

The fabrics of this invention may be made into a face mask or respirator by any method known in the art to be effective. In this regard, referring now to FIG. 12, there are shown, respectively, a frontal perspective view of a face mask; and a back perspective view of the face mask. As can be seen, the face mask 10 comprises a body 12 for covering the mouth and nose of a human wearer, and further comprises one or more than one extension 14 joined to the body 12 for securing the facial mask 10 to the head of the wearer. The body 12 comprises a material 16 having a front surface 18 and an opposing back surface 20. The body 12 further comprises a perimeter 22 comprising a top edge 24, a bottom edge 26, and two lateral edges 28, 30 each connecting the top edge 24 with the bottom edge 26. The body 12 further comprises a plurality of pleats 32, each pleat extending from one lateral edge 28 to the other lateral edge 30, the pleats 32 allowing expansion of the body 12 centrally thereby forming a convex shape toward the front surface 18 of the body 12 when expanded, in order to more closely approximate the facial curves of a wearer of the facial mask 10. In exemplary embodiments of the present invention, the body 12 may be made of the inventive SM or SMP fabric.

Now that embodiments of the present invention have been shown and described in detail, various modifications and improvements thereon will become readily apparent to those skilled in the art. Accordingly, the spirit and scope of the present invention is to be construed broadly and not limited to the foregoing specification.

1. A nonwoven fabric comprising:
a first layer made of spunbond fibers forming a first surface of the fabric; and
a second layer made of meltblown fibers,
wherein the first layer is bonded with the second layer, and
wherein the spunbond fibers of the first layer are interspersed with the meltblown fibers of the second layer so that the nonwoven fabric exhibits enhanced breathability and filtration properties.

2. The nonwoven fabric of claim 1, wherein the first surface of the nonwoven is smooth, and the fabric has a textured second surface opposite the first surface.

3. The nonwoven fabric of claim 1, wherein the first surface of the nonwoven is textured, and the fabric has a smooth second surface opposite the first surface.

4. The nonwoven fabric of claim 1, wherein the fabric forms part of a facemask.

5. The nonwoven fabric of claim 1, wherein the first layer comprises fibers having an average thickness of 12 to 20 microns.

6. The nonwoven fabric of claim 1, wherein the first layer comprises additives of a type selected from the group consisting of: barium titanate (BaTiO3), magnesium stearate and tourmaline.

7. The nonwoven fabric of claim 1, wherein the second meltblown layer comprises additives of a type selected from the group consisting of: barium titanate (BaTiO3), magnesium stearate or tourmaline.

8. The nonwoven fabric of claim 1, wherein the fabric comprises small bonding impressions with a size lower than 1 mm², where size in this context means the surface area of the lowest part of the bonding impression.

9. The nonwoven fabric of claim 1, wherein the first layer of spunbond fibers has a basis weight of at least 5 gsm.

10. The nonwoven fabric of claim 1, wherein the first layer of spunbond fibers has a maximum basis weight of at least 15 gsm.

11. The nonwoven fabric claim 1, wherein the spunbond layer to meltblown layer basis weight ratio is in a range of 0.5-1.5.

12. The nonwoven fabric of claim 1, wherein the nonwoven fabric has an air permeability higher than 20 cfm.

13. The nonwoven fabric of claim 1, wherein the nonwoven fabric has a nGMT of at least 15.

14. The nonwoven fabric of claim 1, further comprising a third layer made of spunbond fibers, wherein the third layer is in direct contact with the second layer of meltblown fibers, and wherein the spunbond fibers of the third layer are hydrophilized so that the second layer of meltblown fibers exhibits a surface energy gradient.

15. The nonwoven fabric of claim 1, wherein the fabric passes requirements of ASTM F2100-11 (2011) REQUIREMENTS FOR MEDICAL FACE MASKS

16. A method of making a nonwoven fabric comprising:
depositing spunbond fibers on a moving belt to form a spunbond batt;
depositing meltblown fibers on the spunbond batt to form a meltblown layer;
conveying the spunbond batt and the meltblown layer to a bonding station; and
bonding the spunbond batt to the meltblown layer at the bonding station by a calendering process in which the spunbond batt and the meltblown layer are fed through a nip formed by calendering rolls, wherein
the bonding step results in the spunbond fibers of the spunbond batt being interspersed with the meltblown fibers of the meltblown layer so that the nonwoven fabric exhibits enhanced breathability and filtration properties.

17. The method of claim 16, wherein the calendering rolls comprise a smooth roll and a patterning roll having a pattern of protrusions, the smooth roll faces and is in direct contact with the spunbond layer, and the patterning roll is heated to a maximum of 152° C.

18. The method of claim 16, wherein a Melt Flow Rate of meltblown grade of the meltblown fibers is within a range of 1000-2000 g/10 min.

19. The method of claim 16, wherein the meltblown layer is produced from at least two melblown beams where at least one meltblown beam produce fibers from a melblown grade at a Melt Flow Rate in the range of 1000-2000 g/10 min and at least one other meltblown beams produces fibers from a melblown grade at a Melt Flow Rate in the range of 400-1000 g/10 min.

20. A nonwoven fabric comprising:
a first layer made of spunbond fibers forming a first surface of the fabric; and
a second layer made of meltblown fibers,
wherein the first layer is bonded with the second layer, and
wherein the second layer made of meltblown fibers comprises bonding impressions, and
wherein the fabric has a first surface that is smooth and a second surface opposite the first surface that is textured.
